(19) United States
(12) Patent Application Publication
(10) Pub. No.: US 2016/0006731 A1
(43) Pub. Date: Jan. 7, 2016

(54) DOCUMENT AUTHENTICATION

(71) Applicant: SECURITYDAM LTD., Tel Aviv (IL)

(72) Inventor: Yehuda ZISAPEL, Tel Aviv (IL)

(21) Appl. No.: 14/766,461

(22) PCT Filed: Feb. 7, 2013
(86) PCT No.: PCT/IB13/50999

§ 371 Date: Aug. 7, 2015

(51) Int. Cl. H04L 29/06; G06F 21/32

(52) U.S. Cl. CPC H04L 63/0861; G06F 21/32; H04L 63/083

(57) ABSTRACT

A method of authenticating a document transmitted to a service, the method comprising: selecting or inserting at least one keyword in a copy of the document as received by the service; receiving a biometric response to the received document from a user indicated as having transmitted the document; identifying a keyword of the at least one keyword present in the biometric response; and determining whether the received document may be considered a true copy of the transmitted document responsive to the identified keyword.

### FIELD

Embodiments of the invention relate to biometric authentication of a document.

### BACKGROUND

It is frequently required to authenticate a user's identity before authorizing him or her to use a service. Familiar services that may require such authorization are by way of example: financial and banking services that provide access to and control of personal banking and investment accounts; on-line purchasing services that involve monetary transfer to vendors; and cloud computing and storage that enable access to potentially sensitive data.

Many services require an authentication procedure conventionally referred to as a multi factor authentication procedure (MFA) to authenticate a user and authorize the user access to the services. In a MFA procedure a user is required to provide an appropriate response to a challenge for each of a plurality of categories of responses. The categories are referred to as “authentication factors”. A common MFA is referred to as a two-factor authentication (2FA) in which a user is challenged with at least two of three authentication factors: a knowledge factor, which tests something the user is supposed to know, for example a password; a possession factor, which requires presentation of something the user has, for example a credit card or smartphone; and an inherence factor, which requires that the user present something that characterizes the user, for example, a biometric feature such as a fingerprint, voiceprint, or iris scan.

By way of a very common example, when a bank customer attempts to withdraw cash from an automatic teller machine (ATM), he or she must satisfy a 2FA identity authentication procedure, before the ATM will provide the cash. The identity authentication typically requires that the bank customer insert a credit card (the possession factor) into a card reader and enter a matching pin number (the knowledge factor) on a keypad. By way of another example, a user using a PC or tablet to download or upload a document from or to the cloud may be required to undergo a three factor authentication procedure comprising entering both a pass-phrase and a one-time pass-code from a pass-code generator in his possession. Generally, a document submitted by a user who has been authorized to use a service is considered acceptable and appropriate to be acted upon by the service.

### SUMMARY

An aspect of an embodiment of the invention relates to providing a method for biometrically authenticating whether a document comprising text that a service receives from a user for acceptance by the service, is the document intended by the user in whose name the document is submitted to the service. The document may be in any format from which text may be extracted, for example ASCII or Unicode or similar computer-readable format, or an image file from which text may be extracted by Optical Character Recognition (OCR).

In an embodiment of the invention, authenticating the document as the document intended by the user for acceptance by the service comprises comparing the text with an audio stream including speech vocalized by the user to determine whether a keyword, and/or a pattern of keywords, in the text is vocalized in the speech. Keywords in the text that are vocalized in the audio stream may be identified using any of various word spotting methods known in the art. Optionally, authenticating the text comprises verifying whether speech in the audio stream is speech voiced by the user in whose name the document is submitted (speaker verification). If the document is verified as authentic, it may be accepted by the service. If the document is determined not to be authentic it may not be accepted, or if accepted, it may be tagged with a warning or alarm indicating that the document may have been tampered with.

In an embodiment of the invention, authenticating the document comprises comparing text in the document with a sample text, hereinafter referred to as “biometric script” or “script”, that the user manually inputs to a keyboard and/or a touchscreen to determine whether a keyword, and/or a pattern of keywords, in the text is reproduced in the script. Biometric script is script that has been endowed with distinctive character as a result of, and correlated with, biometric features of the person who generated the text. Optionally, authenticating the script comprises verifying whether the script is created by the user in whose name the document is submitted to the service. Verifying a script as script created by the “named” user may comprise using any of various methods for identifying manually generated script with a particular person responsive to biometric features of the person that produced the biometric script and associated distinctive character to the script. For example, verifying biometric script may comprise using a handwriting identification algorithm to identify the user. Verifying script may comprise processing script responsive to features, for example speed of character input, and/or error rate that characterizes manual input of the script to identify the user.

Authentication of a document in accordance with an embodiment of the invention may be determined responsive to a number and/or type of the keywords identified in the document that are vocalized in the audio stream or reproduced in the biometric script provided by the user for authentication of the document. In an embodiment of the invention, keywords are associated with weighting factors responsive to their respective degrees of relevance to the text, and the weighted keywords are used to determine whether the document is authentic. For an audio stream provided for authentication of a document in accordance with an embodiment of the invention, authentication may be determined responsive to syntax or semantics characterizing speech in the audio stream.

Hereinafter, an audio stream and biometric script that is intended to be a function of a keyword in a document and is generated in response to the document being authenticated in accordance with an embodiment of the invention may be referred to generically as a “biometric response” to the document.

A keyword in a text may be any component of the text, such as for example, a character string, a word, or a phrase, in the text as received by the service or inserted into the document by the service after its receipt that can be vocalized or manually reproduced in biometric script and is considered to be relevant to understanding or identifying the text.

By way of example, bank designations, account numbers, and amounts of money to be paid out or received, may be keywords in text of a document instructing a bank with regard to transfer of funds. Words in titles of images in a document may function as keywords. In an embodiment of the invention, a keyword may be a component of the text at a particular location in the text. For example, a keyword may be an n-th word of a particular sentence in the text or an n-th paragraph in the text. In an embodiment of the invention, an inserted keyword may by way of example be a string of digits or a nonsense word inserted into the text that is intended for identification and vocalization by the user upon receiving a “return copy” of the text from the service. A keyword may also be a figure, icon, symbol, pictogram or other recognizable colored or black and white mark, hereinafter generically referred to as a figure, in the text that may be audibly described or manually reproduced in biometric script.

There is therefore provided in accordance with an embodiment of the invention a method of authenticating a document transmitted to a service, the method comprising: selecting at least one keyword or inserting at least one keyword in a copy of the document as received by the service; receiving a biometric response for the received document from a user indicated as having transmitted the document; identifying a keyword of the at least one keyword present in the biometric response; and determining whether the received document may be considered a true copy of the transmitted document responsive to the identified keyword.

Optionally, the at least one keyword comprises any component of the document as received or after keyword insertion that may be described in speech, vocalized, or manually reproduced in biometric script. Optionally, the at least one keyword comprises a string of symbols. Optionally, the symbols are randomly chosen.

In an embodiment of the invention, the at least one keyword comprises a word.

In an embodiment of the invention, the at least one keyword comprises a figure.

In an embodiment of the invention, a keyword of the at least one keyword is inserted at a randomly chosen location in the document.

The method in accordance with an embodiment of the invention comprises requesting that the biometric response include a keyword of the at least one keyword. Optionally, requesting inclusion of a keyword of the at least one keyword comprises indicating a location in the document at which the keyword is located.

In an embodiment of the invention, the biometric response comprises an audio stream comprising speech. Optionally, identifying a keyword of the at least one keyword comprises processing the audio stream using a word spotting algorithm.

In an embodiment of the invention, the biometric response comprises biometric script manually input to a keyboard and/or a touchscreen. Optionally, the biometric script comprises handwriting. Additionally or alternatively the biometric script optionally comprises a drawn figure. In an embodiment of the invention, the biometric script comprises typed script.

In an embodiment of the invention, identifying a keyword of the at least one keyword comprises processing the biometric script using a pattern recognition algorithm.

The method in accordance with an embodiment of the invention comprises determining how many keywords are identified in the biometric response and determining whether the received document is considered a true copy responsive to the number of keywords identified.

In an embodiment of the invention, the method comprises weighting each identified keyword with a weight and determining whether the received document is considered a true copy responsive to the weighted keyword.

In an embodiment of the invention, the method comprises determining whether the biometric response is generated by the indicated user. Optionally, the method comprises determining that the document is authentic only if the biometric response is determined to be generated by the indicated user.

In an embodiment of the invention, the method comprises determining that the document is authentic if it is considered to be a true copy.

In an embodiment of the invention, the copy of the document is received via at least one or any combination of, email, http, or an interactive session.

In an embodiment of the invention, the method comprises transmitting a marked up copy of the document that indicates the at least one keyword and requesting that the user generate the biometric response responsive to the marked up copy.

There is further provided in accordance with an embodiment of the invention an authentication system configured to authenticate a document submitted to a service as a document submitted by a user subscribed to the service, the authentication system comprising an authentication engine operative to: receive the submitted document from the service; select at least one keyword or insert at least one keyword in the submitted document; receive a biometric response for the document from a user indicated as having submitted the document; identify a keyword of the at least one keyword present in the biometric response; and determine whether the received document may be considered a true copy of the transmitted document responsive to the identified keyword.

Optionally, the authentication system comprises a database having biometric templates of subscribers to the service and wherein the authentication engine is operative to determine whether the biometric response was generated by the indicated user responsive to a biometric template in the database. Optionally, the authentication system determines the document to be authentic if the document may be considered a true copy. Optionally, the authentication system determines the document to be authentic if the document is determined to have been submitted by the indicated user. In an embodiment of the invention the authentication system determines the document to be authentic if the document is determined to be a true document submitted by the indicated user.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the description and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1 shows a flow diagram of a document authentication procedure in accordance with an embodiment of the invention;

FIG. 2 schematically shows a system for document authentication in accordance with an embodiment of the invention; and

FIG. 3 shows a user-authenticator sequence flow diagram that illustrates a sequence of interactions that may occur between a user and an authenticator to authenticate a document in accordance with an embodiment of the invention.

### DETAILED DESCRIPTION

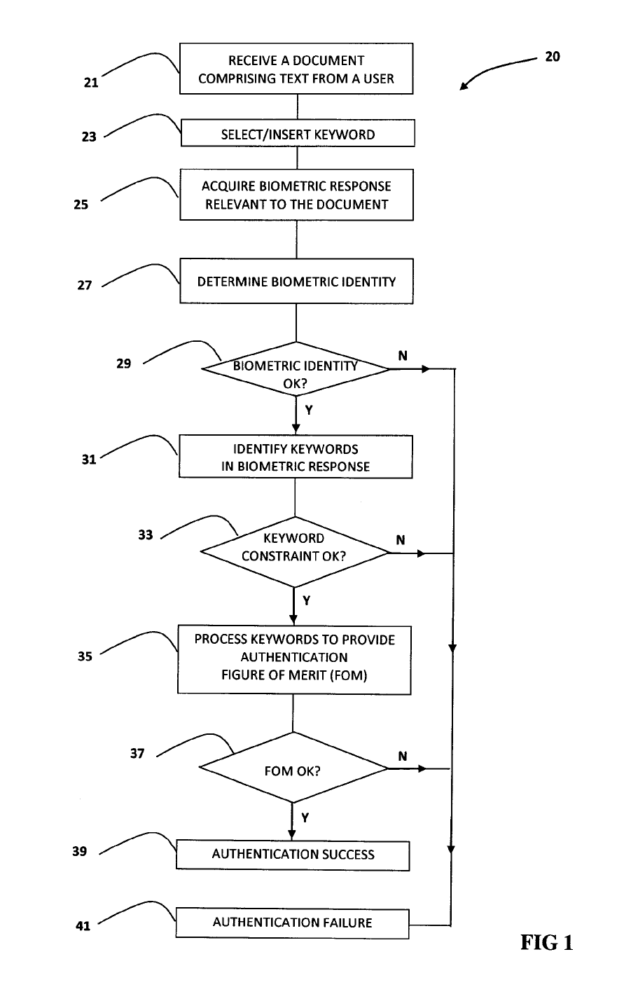

FIG. 1 shows a flow diagram of a document authentication algorithm 20 for authenticating a document comprising text that a user submits for acceptance and use by a service, in accordance with an embodiment of the invention. The service may be any functionality configured to receive documents, and accept and optionally execute actions responsive to the documents subject to their authentication as documents submitted by an authorized person.

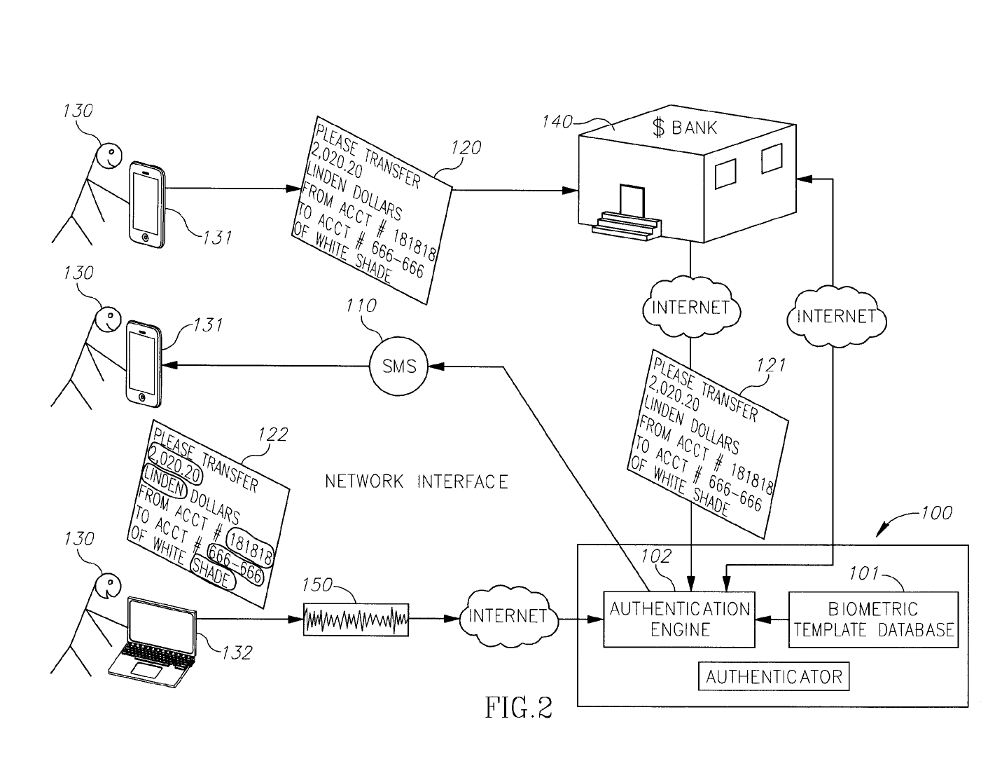

Authentication algorithm 20 is implemented by a system, hereinafter referred to as an authenticator system or an authenticator, which comprises suitable hardware and a computer executable instruction set that supports the algorithm. The authenticator may be a centralized system or a distributed, optionally cloud based, system. An authenticator, its components, and operation, in accordance with an embodiment of the invention are discussed below with reference to FIG. 2.

In the following discussion of algorithm 20 actions executed in accordance with the algorithm may be referred to as being executed by the algorithm. When an action is referred to as being performed or undertaken by the algorithm, it may be understood that the action is executed by a component or combination of components of the authenticator or an entity cooperating with the authenticator to provide authentication. A component of the authenticator may be a hardware component and/or an instruction of an instruction set comprised in the authenticator.

In a block 1 of algorithm 20 the authenticator receives the document from the service to which the user submitted the document for acceptance and, optionally, performance of a task desired by the user. By way of example, the document may be a document submitted to a bank by the user comprising instructions requesting the bank to carry out a financial transaction, such as transferring funds from the user's account, making a payment to a creditor, or purchasing shares. The document may comprise a confidential report that the user submitted to a network for distribution to a select group of decision makers in a government authority or a business enterprise, or an image optionally having textual indicia that the user submitted for storage in a cloud memory.

The user may have communicated the document to the service configured in a convenient format, such as fax, email, hypertext transfer protocol (HTTP), or a file transfer protocol (FTP), via any suitable communication network using any of various communication devices, such as a smartphone, a personal digital assistant, a tablet, a laptop, or a desktop. The communication network may comprise at least one or any combination of, a mobile phone network, the Internet, a local area network (LAN), a wide area network (WAN), and a WiFi network.

The document may be associated with an identifier that identifies the user or a communication device that the user is authorized to use to submit the document to the service. For example, the identifier may be a user ID, name, or email address, or pass word, or biometric identification etc. that the user submits with the document, or an international mobile subscriber number (IMSI) of a SIM (subscriber identity module) card in a smartphone that the user uses to submit the document.

In a block 23, algorithm 20 processes the document to select at least one keyword, an “original keyword” that the document as received by the service comprises, and/or to insert at least one keyword into the document, which may be used to identify the document in accordance with an embodiment of the invention. The at least one keyword may be any textual or non-textual feature of the document, before or after processing by algorithm 20, that may be vocalized, audibly described, and/or manually reproduced in biometric script to provide a biometric response to the document.

A keyword as noted above may for example be a character string, a word, a phrase, icon, figure, mark, symbol, or punctuation mark in the document as received by the service or inserted into the document by the algorithm after its receipt, which is considered advantageous for identifying the text. By way of specific examples, bank designations, account numbers, and amounts of money to be paid out or received, may be keywords in a document comprising text instructing a bank with regard to transfer of funds. Words in a title of an image in a document, or indicia indicating features of the image may function as keywords. In an embodiment of the invention, a keyword is a component of the document at a particular location in the document. For example, a keyword may be a third word in a first sentence of second and seventh paragraphs in the document text. An inserted keyword may be a nonsense phrase, for example the words, “cow jumped over the moon”, inserted in the midst of a paragraph in a document discussing an armament system or a random code or random phrase added to the document.

In a block 25 algorithm 20 acquires a biometric response for the submitted document from the user. The biometric response may be an audio stream comprising speech and/or biometric script provided by the user that is relevant to the document. Acquiring a biometric response relevant to the document may comprise instructing the user what type of biometric response to provide and how to provide it. For example, if the required biometric response comprises an audio stream, algorithm 20 may instruct the user to speak portions of the text comprising the selected and/or inserted keywords into a smartphone or other device, such as a laptop that supports voice over Internet protocol (VoIP), to provide the audio stream for transmission to the algorithm. If the required biometric response is a biometric script, the algorithm may instruct the user to write a portion of the text comprising the selected and/or inserted keywords on a touchscreen of a tablet or smartphone for transmission to the algorithm. Instructions may be sent to the person in any suitable format such as a text message, email, or in an interactive session, via a communication device the user uses to connect to the service and/or the authenticator.

In an embodiment of the invention, the instructions comprise a copy of at least a portion of the document with text in the portion that is to be spoken or reproduced on a touchscreen by the user to provide the biometric response appropriately indicated, for example by highlighting, bold scripting, underlining, or by location in the document. Optionally, the user is requested to confirm by voice or script whether the spoken or reproduced keywords accord with content of the document which the user submitted to the service.

In an embodiment of the invention, a copy of the document is not sent to the user. The user is expected to have access to the document and is asked to read out loud or reproduce on a touchscreen portions of the document containing the keywords. Algorithm 20 may indicate which portions of the document are to be spoken or “touchscreen copy” by their respective locations in the text. For example, the user may be asked to read out loud, or touchscreen copy, a second paragraph on a first page of the document, or a serial number in a text box that the document comprises. Optionally, the user is instructed to speak or touchscreen copy any portion or portions of the text that the user may consider advantageous for identifying the text.

In a block 27, algorithm 20 optionally processes the biometric response to determine an identity, a “biometric identity”, of the person who generated the biometric response. In an embodiment of the invention, algorithm 20 has access to a “biometric database” comprising biometric templates provided by users subscribed to the service for which algorithm 20 is performing document authentication.

The biometric templates may comprise voiceprints or “scriptprints” of the users subscribed to the service. A subscriber's voiceprint comprises data that may be used to identify speech voiced by the subscriber and distinguish the speech from speech voiced by others. A voiceprint (voice signature) may for example comprise samples of words, phrases, or sentences advantageous for use as keywords in identifying the user and authenticating a document as a document submitted by the user. A subscriber voiceprint in accordance with an embodiment of the invention may comprise samples of vocalizations of keywords advantageous for authenticating particular types of documents. For example, the voiceprint may comprise vocalizations of numbers and names of currencies advantageous for determining if an audio stream generated to authenticate a document comprising instructions to a bank in accordance with an embodiment of the invention was generated by the user. A voiceprint may comprise any representation of the subscriber's speech known in the art to correlate highly with the subscriber's identity. The voice signature identification can be with regard to a set of predefined words or generally to a random selection of words, numbers or other forms of speech.

A scriptprint of a user subscribed to the service, similarly to a voiceprint may comprise data advantageous for distinguishing the subscriber's manually generated script from script generated by others. For example, as in a subscriber voiceprint, the scriptprint may comprise samples of words, phrase or sentences that may function as keywords advantageous for authenticating documents comprising instructions to a bank or a technical document submitted to a business or government agency, in accordance with an embodiment of the invention. The scriptprint may comprise any representation of the subscriber's writing or drawing known in the art to correlate with the subscriber's identity.

In an embodiment of the invention, the algorithm uses the templates and the biometric response provided by the user in accordance with any of various voice recognition methods for verifying user identity responsive to features of the biometric response to determine the “biometric identity”, of the user, and a link to the document marked text.

In a decision block 29 algorithm 20 determines if the biometric identity matches an ID of the user submitted with the document or if the biometric identity matches an ID of a user authorized to use the communication device identified by the identifier submitted with the document. If the biometric identity does not match the submitted user ID or a user ID associated with the identifier of communication device, algorithm 20 optionally proceeds to a block 41 and determines that authentication has failed and notifies the service and optionally the user.

If on the other hand if algorithm 20 determines in decision block 29 that matches the user ID or a user ID associated with the communication device identifier, algorithm 20 optionally proceeds to a block 31. In block 31, algorithm 20 identifies keywords in the biometric response provided by the user. If the biometric response comprises an audio stream, algorithm 20 uses any appropriate word spotting algorithm for identifying keywords. If the biometric response comprises a biometric script, algorithm 20 may use any appropriate pattern recognition algorithm, such as by way of example, a text character recognition algorithm, handwriting recognition algorithm, or a pattern recognition program that recognizes figures, to identify keywords in the biometric script.

In a decision block 33 algorithm 20 determines if a number of the identified keywords or the types of the identified keywords satisfy a predetermined keyword constraint. For example, the constraint may require that a threshold, minimum number of keywords selected or inserted by algorithm 20 in block 23 be identified in the biometric response. Optionally the constraint may require in decision block 33 that a threshold number of a specific type of keywords selected or inserted by algorithm 20 in block 23 be identified in the biometric response.

If the keyword constraint is not satisfied algorithm 20 proceeds to block 41 to determine that authentication has failed and notify the service and/or the user of the failure. On the other hand if the keyword constraint is satisfied, in a block 35 algorithm 20 optionally processes the keywords to provide a figure of merit (FOM) for the biometric response that may be used to determine if the document received by the service is acceptable by the service as sufficiently close to being a “true copy” of the “original” document submitted by the user to the service. Hereinafter, a document acceptable by a service as a true copy of a document submitted by a user may be referred to as a true copy. The figure of merit may for example be a function of the keywords weighted by weights responsive to how important the keywords are in identifying the document as a true copy. The figure of merit may be a figure of merit generated by a classifier algorithm, such as a support vector classifier or principle component classifier.

In decision block 37 algorithm 20 determines if the FOM provided in block 37 indicates whether or not the document received by the service is a true copy of the original document. If the FOM indicates the received document is not a true copy in block 41 algorithm 20 determine that authentication has failed and notifies the service and optionally the user of the failure. If on the other hand the FOM indicates that the received document is a true copy, in a block 39 algorithm 20 determines that authentication has succeeded and notifies the service and optionally the user of successful authentication.

FIG. 2 schematically shows an authenticator 100 authenticating a document 120 submitted by a user 130 to a service, optionally a bank 140 of which the user is a customer, in accordance with an embodiment of the invention. Authenticator 100 optionally comprises a biometric template database 101, an authentication engine 102, and a communication interface module (not shown) for interfacing the authenticator to at least one communication network for transmitting and receiving communication signals. Biometric template data base 101 comprises voiceprints and/or scriptprints of customers of bank 140.

Authenticator 100 optionally operates in accordance with flow diagram 20 and may comprise an instruction set implemented by any suitable component or combination of components, such as by way of example, a computer running appropriate software or dedicated hardware designed to perform the desired function. Authenticator 100 may be centralized or distributed, and optionally cloud based system. Authenticator 100 may be wholly or at least partially housed at bank 140, or may be a remote system located outside of the bank in the cloud. By way of example in FIG. 2 authenticator 100 is schematically shown as a remote entity that communicates with the bank, optionally via the Internet, to authenticate documents.

User 130 optionally uses any suitable communication device, such as, as shown by way of example in FIG. 2 a smartphone 131 to draft and transmit document 120 as an email or attachment to an email or via a web-based application to bank 140 over a mobile network to which the user is subscribed. Document 120 comprises text instructing the bank to transfer 2,020.20 Linden dollars from the user's Acct #181818 to Acct #666-666 in the name of “White Shade”. An identifier of user 130, such as a user ID, name, email address or smartphone IMSI accompanies document 120. Document 120 as transmitted by user 130 is received by bank 140 as a document 121, which may be different from transmitted document 120 if for example the transmitted document was corrupted or tampered with during transmission. Upon receipt of the email, bank 140 forwards a copy of document 121 and its associated identifier to authenticator 100.

Authentication engine 102 processes the received document 121 to select a set of keywords in the document advantageous for authenticating the document in accordance with an embodiment of the invention. The authentication engine optionally generates a marked up copy 122 of document 121 in which the selected keywords are singled out, optionally by highlighting framing, or keyword location. Optionally, the verification engine inserts a keyword consisting of a string of digits or a nonsense word at a randomly chosen location in the text. Authenticator 100 may transmit the marked up copy 122 to smartphone 131, optionally over the Internet or the mobile network to which user 130 is subscribed using a suitable mobile file transfer protocol. In addition, authenticator 100 may send a short message service (SMS) communication to smartphone 131 instructing user 130 to access the marked up copy 122 and access a web site or to call a phone number to open a voice channel to the authenticator. The SMS or web-based application further instructs user 130 to read the marked keywords in marked up copy 122 into a suitable device to send an audio stream comprising the user's vocalizations of the keywords to authenticator 100. User 130, optionally decides to use a laptop 132 to display the document and read the keywords into a microphone comprised in the laptop to generate the required audio stream. The audio stream is schematically represented by an analog sound track 150 in FIG. 2 and may hereinafter be referenced by the numeral 150 labeling the sound track. The SMS or web-based application may also requests that the user include in the audio stream 150 a vocal assertion as to whether or not the marked keywords in marked up copy 122 are identical to corresponding keywords in original document 120 that the user sent to bank 140.

Upon receiving audio stream 150 authenticator engine 102 searches biometric template database 101 to determine if the database comprises a voiceprint associated with the identifier of user 130 that accompanied document 121. If a voiceprint associated with the user 130 identifier is located in biometric template database 101, the voice print is used to determine whether audio stream 150 may be considered to have been generated by user 130. If the voice print is not found, or if the audio stream is determined not to be vocalized by user 130, authenticator 100 transmits a message to bank 140 that the document has failed authentication (optionally with an specific indication as to the reason for the failure) and bank 140 notifies user 130 of the failure and refuses to accept document 120.

If the voiceprint is found and audio stream 150 determined to be vocalized by user 130, authentication engine 102 performs word-spotting of the audio stream to identify keywords vocalized in the audio stream. The authentication engine processes the identified keywords, optionally in accordance with actions indicated in blocks 33-39 and discussed above to determine if document 121 as received by bank 140 is a true copy of document 120 as sent by user 130. If document 121 is determined to be a true copy, the document is considered to be authentic and authenticator 100 transmits a message to that effect to bank 140. The bank in turn notifies user 130 that it has authenticated document 120 and proceeds to carry out the instructions in the document.

It is noted that in an embodiment of the invention authenticator 100 does not transmit a marked up copy 122 to user 130. Instead in SMS 110 authenticator 100 instructs user 130 to provide an audio stream comprising vocalized sections of document 120 which the user sent to bank 140 that are expected to contain the keywords selected by authentication engine 102 from document 121. If the audio stream contains the keywords and they are homologous with the keywords in document 121, document 121 is considered to be a true copy of document 120.

In an embodiment of the invention verifier 100 does not transmit a marked up copy to the user, but rather presents the user, via an interactive interface, with representations of the keywords to be vocalized.

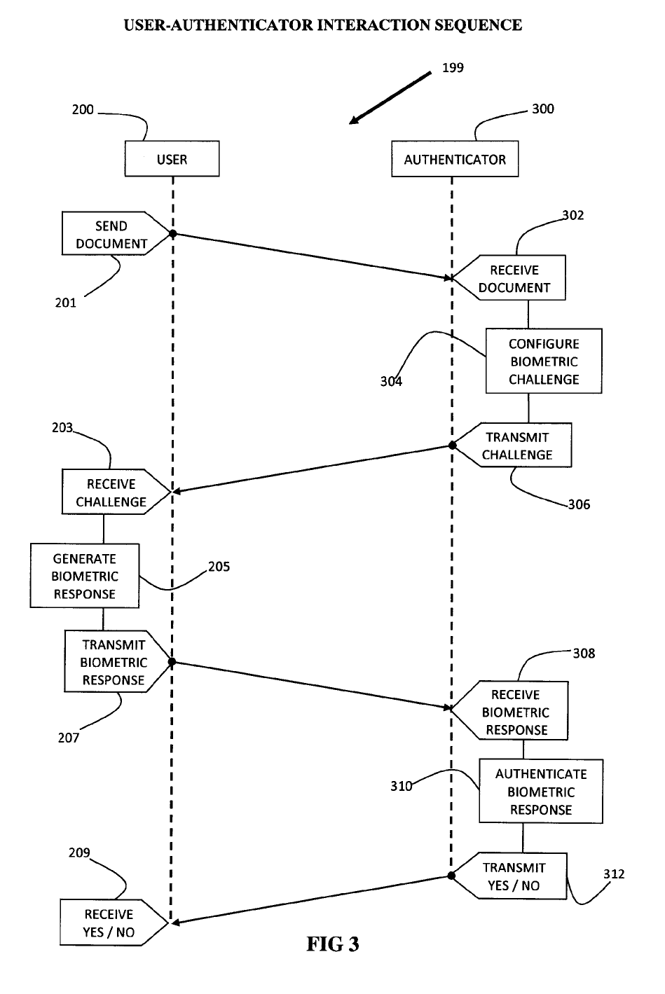

FIG. 3 shows a user-authenticator sequence flow diagram 199 that illustrates a sequence of interactions that may occur between a user 200 and an authenticator 300 in accordance with an embodiment of the invention, to authenticate a document that the user submits to a service (not shown), which uses the authenticator to authenticate documents. Whereas flow diagram 199 schematically shows user 200 communicating directly with authenticator 300, for at least some, if not all the activities shown in the flow diagram, the user may communicate directly with the service, which may access functionalities provided by the authenticator to authenticate documents that the service receives. For simplicity of presentation, interaction sequence flow diagram 199 does not explicitly distinguish between communications to and from user 200 directly with the service and communications to and from user 200 directly with authenticator 300 and shows by way of example, communications as directly with the authenticator.

In a block 201 of sequence flow diagram 199, user 200 transmits a document to the service using any suitable communication device and associated communication channel. Authenticator 300 receives the document in a block 302 and in a block 304 processes the document to configure a biometric challenge to be responded to by the user. Configuring the biometric challenge may include selecting and/or inserting keywords in the received document and determining a format for a biometric response that the user is required to submit to the service to authenticate the document. Determining the format for the biometric response may include determining whether the user is required to generate an audio stream or biometric script to authenticate the document in accordance with an embodiment of the invention. In a block 306 authenticator 306 transmits the configured biometric challenge to user 200.

In a block 203, user 200 receives the biometric challenge and in a block 205 generates the biometric response required by the challenge. In a block 207 the user transmits the biometric response to authenticator 300. Authenticator 300 receives the biometric response in a block 308 and processes the response in a block 310, optionally in accordance with flow diagram 20 of FIG. 1 and a shown in FIG. 2, to determine whether or not the document is considered to be authentic and the service authorized to act on it. In a block 312 authenticator 300 transmits the decision as to whether or not the document is determined to be authentic to user 209 who receives the decision in a block 209 and proceeds responsive to the decision.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method of authenticating a document transmitted to a service, the method comprising:
selecting at least one keyword or inserting at least one keyword in a copy of the document as received by the service;
receiving a biometric response for the received document from a user indicated as having transmitted the document;
identifying a keyword of the at least one keyword present in the biometric response; and
determining whether the received document may be considered a true copy of the transmitted document responsive to the identified keyword.

2. A method according to claim 1 wherein the at least one keyword comprises any component of the document as received or after keyword insertion that may be described in speech, vocalized, or manually reproduced in biometric script.

3. A method according to claim 2 wherein the at least one keyword comprises a string of symbols.

4. A method according to claim 3 wherein the symbols are randomly chosen.

5. A method according to claim 2 wherein the at least one keyword comprises a word.

6. A method according to claim 2 wherein the at least one keyword comprises a figure.

7. (canceled)

8. A method according to claim 1 and comprising requesting that the biometric response include a keyword of the at least one keyword.

9. A method according to claim 8 wherein requesting inclusion of a keyword of the at least one keyword comprises indicating a location in the document at which the keyword is located.

10. A method according to claim 1 wherein the biometric response comprises an audio stream comprising speech.

11. A method according to claim 10 wherein identifying a keyword of the at least one keyword comprises processing the audio stream using a word spotting algorithm.

12. A method according to claim 1 wherein the biometric response comprises biometric script manually input to a keyboard and/or a touchscreen.

13. A method according to claim 12 wherein the biometric script comprises one or more than one of: a handwriting, a drawn figure, and a typed script.

14-15. (canceled)

16. A method according to claim 12 wherein identifying a keyword of the at least one keyword comprises processing the biometric script using a pattern recognition algorithm.

17. A method according to claim 1 and comprising determining how many keywords are identified in the biometric response and determining whether the received document is considered a true copy responsive to the number of keywords identified.

18. A method according to claim 1 and comprising weighting each identified keyword with a weight and determining whether the received document is considered a true copy responsive to the weighted keyword.

19. A method according to claim 1 and comprising determining whether the biometric response is generated by the indicated user.

20. A method according to claim 19 and comprising determining that the document is authentic only if the biometric response is determined to be generated by the indicated user.

21-22. (canceled)

23. A method according to claim 1 and comprising transmitting a marked up copy of the document that indicates the at least one keyword and requesting that the user generate the biometric response responsive to the marked up copy.

24. An authentication system configured to authenticate a document submitted to a service as a document submitted by a user subscribed to the service, the authentication system comprising
an authentication engine operative to:
receive the submitted document from the service;
select at least one keyword or insert at least one keyword in the submitted document;
receive a biometric response for the document from a user indicated as having submitted the document;
identify a keyword of the at least one keyword present in the biometric response; and
determine whether the received document may be considered a true copy of the transmitted document responsive to the identified keyword.

25. An authentication system according to claim 24 and comprising a database having biometric templates of subscribers to the service and wherein the authentication engine is operative to determine whether the biometric response was generated by the indicated user responsive to a biometric template in the database.

26-28. (canceled)
